(19) United States
(12) Patent Application Publication
(10) Pub. No.: US 2024/0406786 A1
(43) Pub. Date: Dec. 5, 2024

(54) METHOD AND DEVICE FOR SUPPORTING SESSION CONTINUITY BY CONSIDERING MAXIMUM ALLOWABLE BIT RATE IN WIRELESS COMMUNICATION SYSTEM

(71) Applicant: SAMSUNG ELECTRONICS CO., LTD., Suwon-si, Gyeonggi-do (KR)

(72) Inventors: Dongeun SUH, Suwon-si (KR); Hoyeon LEE, Suwon-si (KR)

(21) Appl. No.: 18/699,576

(22) PCT Filed: Oct. 7, 2022
(86) PCT No.: PCT/KR2022/015216

§ 371 Date: Apr. 8, 2024

(30) Foreign Application Priority Data
Oct. 8, 2021 (KR) 10-2021-0134468
Oct. 29, 2021 (KR) 10-2021-0147159
Aug. 18, 2022 (KR) 10-2022-0103344

(51) Int. Cl. H04W 28/02; H04W 12/06; H04W 48/18

(52) U.S. Cl. CPC H04W 28/0257; H04W 12/06; H04W 48/18

(57) ABSTRACT

An embodiment of the present disclosure provides an operating method of a Session Management Function (SMF) entity in a wireless communication system. The operating method may include receiving, from an Access And Mobility Management Function (AMF) entity, a Protocol Data Unit (PDU) session creation request message, receiving, from a Unified Data Management (UDM) entity, subscriber information associated with a session of a user equipment (UE), transmitting, to the AMF entity, a response message with respect to the PDU session creation request message, selecting a Policy Control Function (PCF) entity, transmitting, to the selected PCF entity, a session management policy information creation request message comprising Session Migration Information, receiving, from the PCF entity, policy information about a PDU Session which is determined based on a maximum bitrate (MBR) value (UE-Slice-MBR) corresponding to a slice for the PDU Session, and selecting a User Plane Function (UPF) entity to support session continuity by considering an MBR, based on the policy information about a PDU Session.

### TECHNICAL FIELD

The present disclosure relates to a method and apparatus for supporting session continuity by considering a maximum allowable bitrate in a wireless communication system.

### BACKGROUND ART

In order to meet increasing demand with respect to wireless data traffic after the commercialization of 4th generation (4G) communication systems, efforts have been made to develop 5th generation (5G) or pre-5G communication systems. For this reason, 5G or pre-5G communication systems are referred to as ‘beyond 4G network’ communication systems or ‘post long term evolution (post-LTE)’ systems. In order to achieve a high data rate, implementation of 5G communication systems in an ultra-high frequency millimeter-wave (mmWave) band (e.g., a 60-gigahertz (GHz) band) is being considered. In order to reduce path loss of radio waves and increase a transmission distance of radio waves in the ultra-high frequency band for 5G communication systems, various technologies such as beamforming, massive multiple-input and multiple-output (massive MIMO), full-dimension MIMO (FD-MIMO), array antennas, analog beamforming, and large-scale antennas are being studied. Also, in order to improve system networks for 5G communication systems, various technologies such as evolved small cells, advanced small cells, cloud radio access networks (Cloud-RAN), ultra-dense networks, device-to-device communication (D2D), wireless backhaul, moving networks, cooperative communication, coordinated multi-points (COMP), and received-interference cancellation have been developed. In addition, for 5G systems, advanced coding modulation (ACM) technologies such as hybrid frequency-shift keying (FSK) and quadrature amplitude modulation (QAM) (FQAM) and sliding window superposition coding (SWSC), and advanced access technologies such as filter bank multi-carrier (FBMC), non-orthogonal multiple access (NOMA), and sparse code multiple access (SCMA) have been developed.

The Internet has evolved from a human-based connection network, where humans generate and consume information, to the Internet of things (IoT), where distributed elements such as objects exchange information with each other to process the information. Internet of everything (IoE) technology has emerged, in which the IoT technology is combined with, for example, technology for processing big data through connection with a cloud server. In order to implement the IoT, various technological elements such as sensing technology, wired/wireless communication and network infrastructures, service interface technology, and security technology are required, such that, in recent years, technologies related to sensor networks for connecting objects, machine-to-machine (M2M) communication, and machine-type communication (MTC) have been studied. In the IoT environment, intelligent Internet technology (IT) services may be provided to collect and analyze data obtained from connected objects to create new value in human life. As existing information technology (IT) and various industries converge and combine with each other, the IoT may be applied to various fields such as smart homes, smart buildings, smart cities, smart cars or connected cars, smart grids, health care, smart home appliances, and advanced medical services.

Various attempts are being made to apply 5G communication systems to the IoT network. For example, technologies related to sensor networks, M2M communication, and MTC are being implemented by using 5G communication technology using beamforming, MIMO, and array antennas. Application of cloud radio access network (Cloud-RAN) as the above-described big data processing technology may be an example of convergence of 5G communication technology and IoT technology.

Also, efforts are being made to develop a 6th generation (6G) communication system that is about five times faster than a maximum speed of the 5G. Accordingly, in order to achieve a high data rate, implementation in a higher frequency band than the 5G is being considered.

As various services can be provided according to the aforementioned technical features and the development of wireless communication systems, methods of supporting session continuity for seamlessly providing these services are required.

### DISCLOSURE

### Technical Problem

An embodiment of the present disclosure may provide a method and apparatus for effectively providing services in a wireless communication system.

### Technical Solution

Provided is an operating method of a Session Management Function (SMF) in a wireless communication system, the operating method being disclosed as a technical means to achieve the aforementioned technical problems and including receiving, from an Access And Mobility Management Function (AMF), a Protocol Data Unit (PDU) session creation request message, receiving, from a Unified Data Management (UDM), subscriber information associated with a session of a user equipment (UE), transmitting, to the AMF, a response message with respect to the PDU session creation request message, selecting a Policy Control Function (PCF), transmitting, to the selected PCF, a session management policy information creation request message including Session Migration Information, receiving, from the PCF, policy information about a PDU Session which is determined based on a maximum bitrate (MBR) value (UE-Slice-MBR) corresponding to a slice for the PDU Session, and selecting a User Plane Function (UPF) to support session continuity by considering an MBR, based on the policy information about a PDU Session.

Provided is an operating method of an Access And Mobility Management Function (AMF) entity in a wireless communication system, the operating method being disclosed as a technical means to achieve the aforementioned technical problems and including receiving, from a user equipment (UE), a Protocol Data Unit (PDU) session creation request message, selecting a Session Management Function (SMF) entity for a new PDU Session, transmitting, to the selected SMF entity, the PDU session creation request message, and receiving, from the SMF entity, a response message with respect to the PDU session creation request message.

Provided is a Session Management Function (SMF) entity for supporting session continuity by considering a maximum bitrate (MBR) in a wireless communication system, the SMF entity being disclosed as a technical means to achieve the aforementioned technical problems and including a transceiver and at least one processor. The at least one processor may be configured to receive, from an Access And Mobility Management Function (AMF) entity, a Protocol Data Unit (PDU) session creation request message, receive, from a Unified Data Management (UDM) entity, subscriber information associated with a session of a user equipment (UE), transmit, to the AMF entity, a response message with respect to the PDU session creation request message, select a Policy Control Function (PCF) entity, transmit, to the selected PCF entity, a session management policy information creation request message including Session Migration Information, receive, from the PCF entity, policy information about a PDU Session which is determined based on a maximum bitrate (MBR) value (UE-Slice-MBR) corresponding to a slice for the PDU Session, and select a User Plane Function (UPF) entity to support session continuity by considering an MBR, based on the policy information about a PDU Session.

### DESCRIPTION OF DRAWINGS

FIG. 1 is a diagram illustrating a method of informing a NG-RAN that request is a new PDU Session creation request for substituting an old PDU Session, when the NG-RAN controls QoS Flow acceptance based on UE-Slice-MBR in a PDU Session creation procedure based on SSC mode 3, according to an embodiment of the present disclosure.

FIG. 2 is a diagram illustrating a method by which a PCF transfers Alternative QoS Profiles to an NG-RAN by considering that a new PDU Session substitutes an old PDU Session, when the NG-RAN controls QoS Flow acceptance based on UE-Slice-MBR in a PDU Session creation procedure based on SSC mode 3, according to an embodiment of the present disclosure.

FIG. 3 is a diagram illustrating a method of informing a PCF that request is a new PDU Session creation request for substituting an old PDU Session, when the PCF controls QoS Flow acceptance based on UE-Slice-MBR in a PDU Session creation procedure based on SSC mode 3, according to an embodiment of the present disclosure.

FIG. 4 is a diagram illustrating a base station entity according to an embodiment of the present disclosure.

FIG. 5 is a diagram illustrating a user equipment entity according to an embodiment of the present disclosure.

FIG. 6 is a diagram illustrating a network entity according to an embodiment of the present disclosure.

### MODE FOR INVENTION

In the following descriptions of embodiments, descriptions of techniques that are well known in the art and are not directly related to the present disclosure are omitted. By omitting unnecessary descriptions, the essence of the present disclosure may not be obscured and may be explicitly conveyed.

Advantages and features of the present disclosure and methods of accomplishing the same may be understood more readily by reference to the following detailed descriptions of embodiments and accompanying drawings of the present disclosure. However, the present disclosure may be embodied in many different forms and should not be construed as being limited to the embodiments set forth herein.

Hereinafter, terms identifying an access node, terms indicating network entities, terms indicating messages, terms indicating an interface between network entities, and terms indicating various pieces of identification information, as used in the following description, are exemplified for convenience of descriptions. Accordingly, the present disclosure is not limited to terms to be described below, and other terms indicating objects having equal technical meanings may be used.

For convenience of descriptions, the present disclosure uses terms and names defined in the 3^{rd} Generation Partnership Project (3GPP) new radio (NR) rules. However, the present disclosure is not limited to these terms and names, and may be equally applied to communication systems conforming to other standards. In the present disclosure, a base station may indicate a next-generation node B (gNB). Also, the term “terminals (UEs)” may refer to not only mobile phones, Narrowband Internet of Things (NB-IoT) devices, and sensors but also other wireless communication devices.

Hereinafter, a base station is an entity that allocates resources to a terminal, and may be at least one of a gNode B, an evolved node B (eNode B), a Node B, a base station (BS), a radio access unit, a BS controller, or a node on a network. A terminal may include a user equipment (UE), a mobile station (MS), a cellular phone, a smartphone, a computer, or a multimedia system capable of performing a communication function. However, the present disclosure is not limited to the above example.

The present disclosure may be applied to the 3GPP NR (5G mobile communication standards). The present disclosure is applicable to intelligent services (e.g., smart home, smart building, smart city, smart car or connected car, health care, digital education, retail, security, and safety services) based on 5G communication technology and IoT technology.

Wireless communication systems providing voice-based services in early stages are being developed to broadband wireless communication systems providing high-speed and high-quality packet data services according to communication standards such as high speed packet access (HSPA), long term evolution (LTE) or evolved universal terrestrial radio access (E-UTRA), LTE-advanced (LTE-A), LTE-Pro of 3GPP, high rate packet data (HRPD), ultra mobile broadband (UMB) of 3GPP2, and 802.16e of the Institute of Electrical and Electronics Engineers (IEEE).

As a representative example of the broadband wireless communication systems, LTE systems employ orthogonal frequency division multiplexing (OFDM) for a downlink (DL) and employs single carrier-frequency division multiple access (SC-FDMA) for an uplink (UL). The UL refers to a radio link for transmitting data or a control signal from a terminal (e.g., a UE or an MS) to a base station (e.g., an eNB or a BS), and the DL refers to a radio link for transmitting data or a control signal from the base station to the terminal. The above-described multiple access schemes identify data or control information of each user in a manner that time-frequency resources for carrying the data or control information of each user are allocated and managed not to overlap each other, that is, to achieve orthogonality therebetween.

As post-LTE communication systems, i.e., 5G communication systems need to support services capable of freely reflecting and simultaneously satisfying various requirements of users, service providers, and the like. Services considered for the 5G systems include enhanced mobile broadband (eMBB), massive machine-type communication (mMTC), ultra-reliability low-latency communication (URLLC) services, or the like.

Although LTE, LTE-A, LTE Pro or 5G (or NR, next-generation mobile communication) system is mentioned as an example in the following description, embodiments of the present disclosure may also be applied to other communication systems having similar technical backgrounds or channel types. Also, embodiments of the present disclosure are applicable to other communication systems through modification at the discretion of one of ordinary skill in the art without greatly departing from the scope of the present disclosure.

In the description of the present disclosure, detailed descriptions of the related art are omitted when it is deemed that they may unnecessarily obscure the essence of the present disclosure. Hereinafter, embodiments of the present disclosure will now be described with reference to the accompanying drawings.

The 5 mobile communicator network may consist of a 5G UE, a 5G radio access network (RAN), and a 5G core network. The 5G core network consist of network functions (NFs) including an access and mobility management function (AMF) providing a mobility management function with respect to a UE, a session management function (SMF) providing a session management function, a user plane function (UPF) performing a data transmission function, a policy control function (PCF) providing a policy control function, a unified data management (UDM) providing a data management function such as subscriber data, policy control data, etc., unified data repository (UDR) storing data of various NFs, or the like.

In the 5G system, there is a technology referred to as a Session and Service Continuity (SSC) Mode for supporting session continuity so as to enhance Quality-of-Experience (QoE) of a user or support a mission critical service. The SSC consists of three modes, and SSC mode 3 among them may be referred to as Make-Before-Break. When a network determines that it is required to release a SSC mode 3 Protocol Data Unit (PDU) Session currently used by a UE, the network establishes a new PDU Session that can substitute the corresponding PDU Session, and then releases the old PDU Session, thereby supporting session continuity. The UE may migrate traffic flows being transceived via the old PDU Session to the new PDU Session before the old PDU Session is released, and thus, may maintain session continuity.

In the 5G system, a network slicing technology refers to a technology and architecture which enable virtualized and independent multiple logic networks in one physical network. A network provider configures a virtual end-to-end network referred to as a network slice and provides a service to satisfy requirements dedicated for a service or an application. The network slice is identified with an identifier that is Single-Network Slice Selection Assistance Information (S-NSSAI), and a UE transceives data via a PDU session for each slice with respect to allowed slices (S-NSSAIs). A PDU Session consists of a plurality of traffic Flows, and each traffic Flow consists of two types which are a Guaranteed Bitrate Quality-of-Service Flow (GBR QoS Flow) and a non-GBR QoS Flow.

In the 5G system, there is a function for controlling a Maximum Bitrate (MBR) for each network slice for a user (or a UE). In detail, it is controlled that, in specific S-NSSAI, a maximum UL bitrate (e.g., a total amount of bitrates transmitted via UL through GBR QoS Flows and non-GBR QoS Flows for all PDU Sessions of the corresponding S-NSSAI) and a maximum DL bitrate (e.g., a total amount of bitrates transmitted via DL through GBR QoS Flows and non-GBR QOS Flows for all PDU Sessions of the corresponding S-NSSAI) are not to respectively exceed predetermined values of UL UE-Slice-MBR and DL UE-Slice-MBR.

When the UE receives, from an SMF, a message indicating a necessity to change a UPF or the SMF for a PDU session operating in SSC Mode 3, the UE requests creation of a new PDU Session (e.g., a PDU Session having the same Data Network Name (DNN) and S-NSSAI as the old PDU Session) which can substitute the old PDU Session, and when the new PDU Session is created, the UE releases the old PDU Session.

In a substitution procedure of the PDU Session operating in SSC mode 3 (e.g., a procedure in which a new PDU Session is established and an old PDU Session is released), when a bitrate usage by the UE for a slice with respect to the old PDU Session is very high (e.g., when the bitrate already nearly reaches an MBR (UE-Slice-MBR)), QOS Flows of a new PDU Session may be rejected, and thus, there is a scheme for solving this problem.

Hereinafter, in a wireless communication system according to an embodiment of the present disclosure, provided is a scheme for solving a problem in which a QoS Flow may be rejected or restricted due to a usage limit based on an MBR of a UE for each slice with respect to a new PDU Session request requested in changing a UPF or an SMF for a PDU Session of SSC Mode 3.

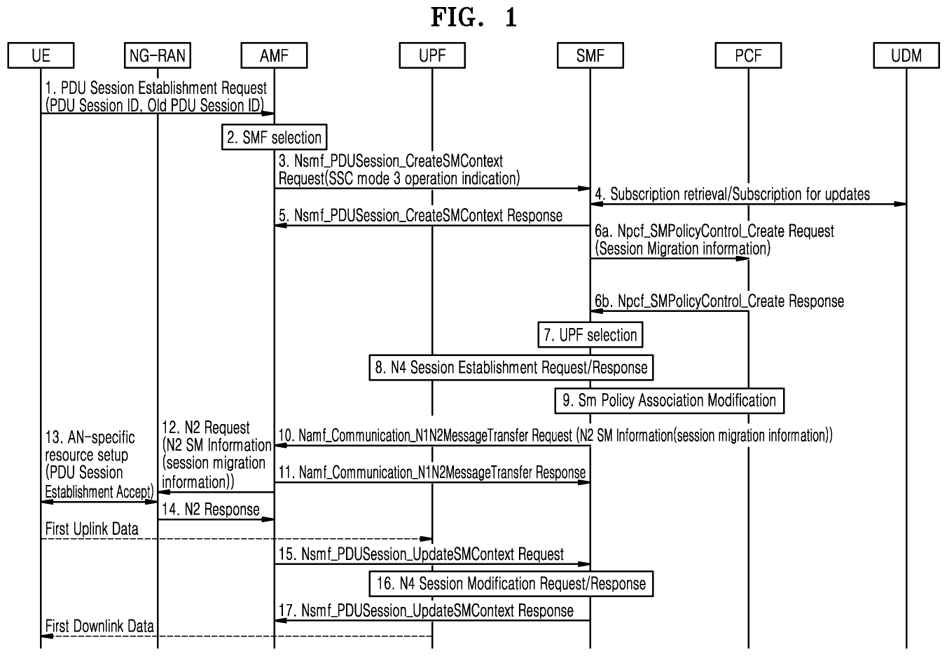

FIG. 1 illustrates a method of informing a NG-RAN that request is a new PDU Session creation request for substituting an old PDU Session, when the NG-RAN controls QoS Flow acceptance based on UE-Slice-MBR in a PDU Session creation procedure based on SSC mode 3, according to an embodiment of the present disclosure.

First, an SMF managing an old PDU Session operating in SSC mode 3 determines to change PDU Session Anchor (PSA)-UPF (or, PSA-UPF and SMF) with respect to the old PDU Session, and transmits a PDU Session Modification Command to a UE. Also, when the SMF determines an SMF change with respect to the PDU Session, the SMF transmits an SMF Reallocation requested indication to an AMF.
In operation 1, after the UE receives the PDU Session Modification Command from the old SMF, the UE may determine to perform a PDU Session Establishment procedure for connection to a data network (DN) that is the same DN of the old PDU Session. The UE transmits a PDU Session Establishment Request message to an AMF, thereby requesting creation of a new PDU Session. Here, based on considering that it is SSC mode 3 PDU Session, the UE may include a new PDU Session ID in a PDU Session ID in the PDU Session Establishment Request message, and may include, in an Old PDU Session ID, an ID of the old PDU Session to be released.
In operation 2, the AMF performs a SMF selection procedure for a new PDU Session. Here, when the SMF Reallocation requested indication is received from the SMF before operation 1 is performed, the AMF may select a new SMF.
In operation 3, when the message from the UE includes an Old PDU Session ID, the AMF transmits, to the SMF, an Nsmf_PDUSession_CreateSMContext Request including an SSC mode 3 operation indication.

According to an embodiment of the present disclosure, the SSC mode 3 operation indication may include the Old PDU Session ID. However, the present disclosure is not limited to the example above.

When the SMF receives the SSC mode 3 operation indication, the SMF may identify that the PDU Session creation request is a request for a new PDU Session for substituting the old PDU Session operating in SSC mode 3.

Alternatively, when the message received from the UE in operation 1 includes the Old PDU Session ID, the AMF may check whether S-NSSAI (i.e., requested S-NSSAI) included in the message received from the UE in operation 1 or S-NSSAI corresponding to the Old PDU Session ID included in the message received from the UE in operation 1 is a slice to which a UE-Slice-MBR function (i.e., a UE-Slice-MBR control function) is applied (i.e., whether the AMF transmitted a UE-Slice-MBR (a maximum bitrate value for each slice for each UE) for corresponding S-NSSAI to the NG-RAN). When the S-NSSAI is a slice to which the UE-Slice-MBR is applied, the AMF configures a new UE-Slice-MBR to be 1) a special value indicating no-limit or 2) a large value that is not restricted due to a UE-Slice-MBR, and transmits a message including information of the configuration to the NG-RAN. The message to be transmitted may include information below:

S-NSSAI, new UE-Slice-MBR, and UE ID.

When the NG-RAN receives the message, the NG-RAN newly configures a UE-Slice-MBR for the UE corresponding thereto to be the new UE-Slice-MBR, and does not perform, based on the configuration, restriction (rejection or modification to QoS Flow establishment) due to a UE-Slice-MBR with respect to the UE ID and the S-NSSAI.

In cases below, the AMF may transmit a message to the NG-RAN so as to re-configure a previous UE-Slice-MBR value.

The case where a timer is set at transmission of a message for new UE-Slice-MBR configuration and then the timer is expired, the case where a PDU session for the PDU session ID included in the message received from the UE in operation 1 is established, or the like.
In operation 4, the SMF receives, from the UDM, subscriber information (e.g., Session Management Subscription data) associated with a session of the UE.

In detail, the SMF may request the data by transmitting a Nudm_SDM_Get Request message to the UDM, and may request subscription by transmitting a Nudm_SDM_Subscribe Request message. In an embodiment, the Nudm_SDM_Get Request message may include at least one of a Subscription Permanent Identifier (SUPI), Session Management Subscription data, a selected DNN, S-NSSAI of the Home Public Land Mobile Network (HPLMN), a Serving Public Land Mobile Network (PLMN) ID, or [NID]. In an embodiment, the Nudm_SDM_Subscribe Request message may include at least one of a SUPI, Session Management Subscription data, a selected DNN, S-NSSAI of the HPLMN, a Serving PLMN ID, or [NID].

When the UDM receives the data request message from the SMF, the UDM may obtain the data from the UDR and may transmit the data to the SMF.
In operation 5, the SMF transmits a Nsmf_PDUSession_CreateSMContext Response message to the AMF, as a response message with respect to operation 3.

Also, the SMF may perform Optional Secondary authentication/authorization on a PDU Session via a Data Network Authentication, Authorization and Accounting (DN-AAA) server.
In operation 6, the SMF performs a procedure for selecting a PCF, and performs a Session Management (SM) Policy Association Establishment procedure with the PCF with respect to the PDU Session.

Here, the PCF may transmit policy information about the PDU Session to the SMF.
In operation 7, the SMF performs a procedure for selecting a UPF with respect to the PDU Session.
In operation 8, the SMF transmits a N4 Session creation request with respect to the PDU Session, and the UPF transmits a response message corresponding to the request to the SMF.
In operation 9, when a Policy Control Request (PCR) Trigger condition received from the PCF in operation 6 is satisfied, the SMF performs a SM Policy Association Modification procedure and thus transmits information corresponding to the PCR Trigger to the PCF.
In operation 10, the SMF transmits a Namf_Communication_N1N2MessageTransfer Request message to the AMF. For example, the Namf_Communication_N1N2MessageTransfer Request message may include at least one of a PDU Session ID, N2 SM information, or a N1 SM container. According to an embodiment of the present disclosure, the PDU Session ID may be an ID created for the PDU Session whose creation is requested by the SMF.

The N2 SM information may be information provided to the NG-RAN, and the N1 SM container may be information provided to the UE.

In an embodiment, when the SMF receives the SSC mode 3 operation indication from the AMF in operation 3, the SMF may transmit N2 SM Information (information to be transmitted to the NG-RAN) including Session Migration Information to the AMF, and thus, may inform the NG-RAN that the PDU Session creation request is a request for the new PDU Session for substituting the old PDU Session operating in SSC mode 3. Also, the SMF may transmit the N2 SM Information (information to be transmitted to the NG-RAN) including Session Migration Information to the AMF, based on a result of local configuration.

For example, the Session Migration Information may include the Old PDU Session ID of the SSC mode 3 operation indication received in operation 3. Also, the Session Migration Information may include a release timer value (e.g., a value transferred to the UE or a value being used by the SMF) with respect to the Old PDU Session (or the previous PDU session), QoS Flow ID(s) of the Old PDU Session, S-NSSAI of the Old PDU Session, or the like.

For example, the N2 SM information may include a PDU Session ID, QoS Flow ID (QFI) (s), QoS Profile(s), CN Tunnel Info, S-NSSAI from the Allowed NSSAI, Session-session Aggregate Maximum Bit Rate (AMBR), and a PDU Session Type.

For example, the N1 SM container may include PDU Session Establishment Accept. Information of the PDU Session Establishment Accept may include at least one of [QOS Rule(s) and QoS Flow level QoS parameters if needed for the QoS Flow(s) associated with the QoS rule(s)], selected SSC mode, S-NSSAI(s), UE Requested DNN, allocated IPv4 address, interface identifier, Session-AMBR, or selected PDU Session Type.
In operation 11, the AMF transmits a Namf_Communication_N1N2MessageTransfer Response message to the SMF, as a response to operation 10.
In operation 12, the AMF may transmit N2 Request (N2 SM information), and a Non-access stratum (NAS) message to the NG-RAN. The NAS message may include the PDU Session ID or the N1 SM container (PDU Session Establishment Accept).
In operation 13, the NG-RAN performs an operation of setting up resources for an Access Network (AN) with the UE, based on the information received from the SMF.
In operation 14, the NG-RAN transmits N2 Response to the AMF. The N2 Response may include at least one of PDU Session ID, Cause, or N2 SM information (PDU Session ID, AN Tunnel Info, List of accepted/rejected QFI(s)). Here, the List of accepted/rejected QFI(s) (QOS Flow ID(s)) may include information about a result of acceptance or rejection with respect to each QoS Flow.

When S-NSSAI (a slice for the PDU Session) received in operation 12 is subject to a limit of an MBR with respect to S-NSSAI for each UE, the NG-RAN may perform acceptance or rejection on each QoS Flow by considering a uplink (UL) UE-Slice-MBR value (an MBR value of the UE for a corresponding slice in a UL direction) pre-received for the corresponding S-NSSAI and a bitrate of the UE which is being used in the UL direction for the corresponding S-NSSAI. Also, when the S-NSSAI (the slice for the PDU Session) received in operation 12 is subject to a limit of an MBR with respect to S-NSSAI for each UE, the NG-RAN may perform acceptance or rejection on each QoS Flow by considering downlink (DL) UE-Slice-MBR value (an MBR value of the UE for a corresponding slice in a DL direction) pre-received for the corresponding S-NSSAI and a bitrate of the UE which is being used in the DL direction for the corresponding S-NSSAI.

When the NG-RAN receives the Session Migration Information in operation 12, the NG-RAN may not perform rejection determination on QoS Flow due to the UL UE-Slice-MBR or the DL UE-Slice-MBR with respect to the S-NSSAI (the slice for the PDU Session) received in operation 12.

Also, even when the NG-RAN does not receive the Session Migration Information in operation 12, the NG-RAN may configure, according to local configuration, a timer (e.g., a rejection determination delay timer) for delaying rejection determination with respect to QoS Flow, and may not perform rejection determination on QoS Flows for a PDU Session. In this case, when the rejection determination delay timer is expired, the NG-RAN may perform rejection determination of QoS Flow due to the UE-Slice-MBR with respect to the QoS Flows. However, when at least one of a plurality of pieces of information is received before the rejection determination delay timer is expired, rejection determination may not be performed on the QoS Flows: information indicating that the QoS Flows are QoS Flows to substitute an old PDU Session, information requesting not to perform the UE-Slice-MBR on the QoS Flows, or the like.

Also, when the NG-RAN receives the Session Migration Information in operation 12, and the Session Migration Information includes Old PDU session ID, the NG-RAN may perform acceptance or rejection determination on each of QoS Flows due to the UL UE-Slice-MBR value or the DL UE-Slice-MBR value with respect to the S-NSSAI (the slice for the PDU Session) received in operation 12, in consideration of a UL bitrate usage and a DL bitrate usage with respect to the QoS Flows included in a PDU Session corresponding to the Old PDU Session ID. In detail, even when a UE-Slice-MBR quota is insufficient, the NG-RAN may additionally allow newly-requested QoS Flows by a total amount of bitrates for traffics (i.e., corresponding old QoS Flows) corresponding to information specified in the Session Migration Information.

Also, when the NG-RAN receives the Session Migration Information in operation 12, and the Session Migration Information includes a release timer value (a value transferred to the UE or a value being used by the SMF) for an Old PDU Session, the NG-RAN may delay rejection determination for QoS Flows due to the UL UE-Slice-MBR value or the DL UE-Slice-MBR value with respect to the S-NSSAI (the slice for the PDU Session) received in operation 12, in consideration of the release timer value.

Also, when the NG-RAN receives the Session Migration Information in operation 12, and the Session Migration Information includes QS Flow ID(s) of an Old PDU Session, and S-NSSAI of the Old PDU Session, the NG-RAN may perform acceptance or rejection determination on each of QoS Flows due to the UL UE-Slice-MBR value or the DL UE-Slice-MBR value with respect to the S-NSSAI (the slice for the PDU Session) received in operation 12, in consideration of a UL bitrate usage and a DL bitrate usage with respect to the QoS Flows (i.e., old QoS Flows) corresponding to the QoS Flow ID(s) or the S-NSSAI. In detail, even when a UE-Slice-MBR quota is insufficient, the NG-RAN may additionally allow newly-requested QoS Flows by a total amount of bitrates for traffics (i.e., the old QoS Flows) corresponding to information specified in the Session Migration Information.
In operation 15, the AMF may transmit an Nsmf_PDUSession_UpdateSMContext Request message to the SMF.
In operation 16, the SMF may transmit a N4 Session Modification Request message to the UPF. When the UPF receives the message, the UPF may transmit a N4 Session Modification Response message to the SMF.
In operation 17, the SMF may transmit an Nsmf_PDUSession_UpdateSMContext Response message to the AMF, as a response with respect to to operation 15.

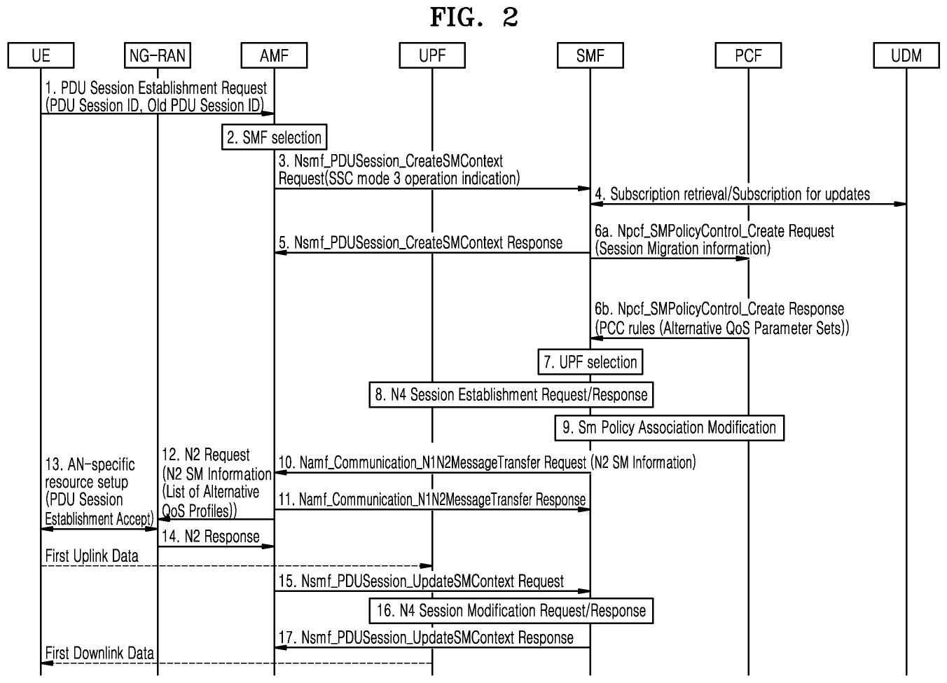

FIG. 2 illustrates a method by which a PCF transfers Alternative QoS Profiles to an NG-RAN by considering that a new PDU Session substitutes an old PDU Session, when the NG-RAN controls QoS Flow acceptance based on UE-Slice-MBR in a PDU Session creation procedure based on SSC mode 3, according to an embodiment of the present disclosure.

First, an SMF managing an old PDU Session operating in SSC mode 3 determines to change PDU Session Anchor (PSA)-UPF (or, PSA-UPF and SMF) with respect to the old PDU Session, and transmits a PDU Session Modification Command to a UE. Also, when the SMF determines an SMF change with respect to the PDU Session, the SMF transmits an SMF Reallocation requested indication to an AMF.
In operation 1, after the UE receives the PDU Session Modification Command from the old SMF, the UE may determine to perform a PDU Session Establishment procedure for connection to a DN that is the same DN of the old PDU Session. The UE transmits a PDU Session Establishment Request message to an AMF, thereby requesting creation of a new PDU Session. Here, based on considering that it is SSC mode 3 PDU Session, the UE may include a new PDU Session ID in a PDU Session ID in the PDU Session Establishment Request message, and may include, in an Old PDU Session ID, an ID of the old PDU Session to be released.
In operation 2, the AMF performs a SMF selection procedure for a new PDU Session. Here, when the SMF Reallocation requested indication is received from the SMF before operation 1 is performed, the AMF may select a new SMF.
In operation 3, when the message from the UE includes an Old PDU Session ID, the AMF transmits, to the SMF, an Nsmf_PDUSession_CreateSMContext Request including an SSC mode 3 operation indication.

According to an embodiment of the present disclosure, the SSC mode 3 operation indication may include the Old PDU Session ID. However, the present disclosure is not limited to the example above.

When the SMF receives the SSC mode 3 operation indication, the SMF may identify that the PDU Session creation request is a request for a new PDU Session for substituting the old PDU Session operating in SSC mode 3.
In operation 4, the SMF receives, from a UDM, subscriber information (e.g., Session Management Subscription data) associated with a session of the UE.

In detail, the SMF requests the data by transmitting a Nudm_SDM_Get Request message to the UDM, and may request subscription by transmitting a Nudm_SDM_Subscribe Request message to the UDM. In an embodiment, the Nudm_SDM_Get Request message may include at least one of a SUPI, Session Management Subscription data, a selected DNN, S-NSSAI of the HPLMN, a Serving PLMN ID, or [NID]. In an embodiment, the Nudm_SDM_Subscribe Request message may include at least one of a SUPI, Session Management Subscription data, a selected DNN, S-NSSAI of the HPLMN, a Serving PLMN ID, or [NID].

When the UDM receives a data request message from the SMF, the UDM may obtain the data from a UDR and may transmit the data to the SMF.
In operation 5, the SMF transmits an Nsmf_PDUSession_CreateSMContext Response message to the AMF, as a response message with respect to operation 3.

Also, the SMF may perform Optional Secondary authentication/authorization on a PDU Session via a DN-AAA server.
In operation 6a, the SMF performs a procedure for selecting a PCF, and performs a Session Management (SM) Policy Association Establishment procedure with the PCF with respect to the PDU Session.

In an embodiment, the SMF may transmit an Npcf_SMPolicyControl_Create Request message to the PCF.

When the SMF receives the SSC mode 3 operation indication in operation 3, the SMF may transmit the Npcf_SMPolicyControl_Create Request message including Session Migration Information to the PCF.
In operation 6b, when the message received in operation 6a includes the Session Migration Information, the PCF may create Alternative QoS Parameter Sets with respect to the requested PDU Session.

In an embodiment, the PCF may transmit a Npcf_SMPolicyControl_Create Response message including Policy and Charging Control (PCC) Rule including the Alternative QoS Parameter Sets to the SMF.
In operation 7, the SMF performs a procedure for selecting a UPF for the PDU Session.
In operation 8, the SMF transmits an N4 Session creation request for the PDU Session to the UPF, and the UPF transmits, to the SMF, a response message thereto.
In operation 9, when a Policy Control Request (PCR) Trigger condition received from the PCF in operation 6b is satisfied, the SMF performs a SM Policy Association Modification procedure and thus transmits information corresponding to the PCR Trigger to the PCF.

In operation transmits a 10, the SMF Namf_Communication_N1N2MessageTransfer Request message to the AMF. For example, the Namf_Communication_N1N2MessageTransfer Request message may include at least one of a PDU Session ID, N2 SM information, or a N1 SM container.

According to an embodiment of the present disclosure, the PDU Session ID may be an ID created for the PDU Session whose creation is requested by the SMF.

The N2 SM information may be information provided to the NG-RAN, and the N1 SM container may be information provided to the UE.

In an embodiment, when the SMF receives the Alternative QoS Parameter Sets from the PCF in operation 6b, the SMF transmits N2 SM Information (information to be transmitted to the NG-RAN) including List of Alternative QoS Profiles to the AMF.

For example, the N2 SM information may include a PDU Session ID, QFI(s), QoS Profile(s), CN Tunnel Info, S-NSSAI from the Allowed NSSAI, Session-AMBR, or a PDU Session Type.

For example, the N1 SM container may include PDU Session Establishment Accept information. The PDU Session Establishment Accept information may include at least one of [QoS Rule(s) and QoS Flow level QoS parameters if needed for the QoS Flow(s) associated with the QoS rule(s)], selected SSC mode, S-NSSAI(s), a UE Requested DNN, an allocated IPv4 address, an interface identifier, Session-AMBR, or a selected PDU Session Type.
In operation 11, the AMF transmits a Namf_Communication_N1N2MessageTransfer Response message to the SMF, as a response with respect to operation 10.
In operation 12, the AMF may transmit N2 Request (N2 SM information), and a NAS message to the NG-RAN. The NAS message may include a PDU Session ID or a N1 SM container (PDU Session Establishment Accept).
In operation 13, the NG-RAN performs an operation of setting up resources for an AN with the UE, based on the information received from the SMF.

In an embodiment, the NG-RAN may transmit a PDU Session Establishment Accept message to the UE.
In operation 14, the NG-RAN transmits N2 Response to the AMF. The N2 Response may include at least one of PDU Session ID, Cause, or N2 SM information (PDU Session ID, AN Tunnel Info, List of accepted/rejected QFI(s)). Here, the List of accepted/rejected QFI(s) (QOS Flow ID(s)) may include information about a result of acceptance or rejection which is performed by the NG-RAN with respect to each QoS Flow of a PDU Session.

When S-NSSAI (a slice for the PDU Session) received in operation 12 is subject to a limit of an MBR with respect to S-NSSAI for each UE, the NG-RAN may perform acceptance or rejection on each QoS Flow by considering a uplink (UL) UE-Slice-MBR value (an MBR value of the UE for a corresponding slice in a UL direction) pre-received for the corresponding S-NSSAI and a bitrate of the UE which is being used in the UL direction for the corresponding S-NSSAI. Also, when the S-NSSAI (the slice for the PDU Session) received in operation 12 is subject to a limit of an MBR with respect to S-NSSAI for each UE, the NG-RAN may perform acceptance or rejection on each QoS Flow by considering a downlink (DL) UE-Slice-MBR value (an MBR value of the UE for a corresponding slice in a DL direction) pre-received for the corresponding S-NSSAI and a bitrate of the UE which is being used in the DL direction for the corresponding S-NSSAI.

When the NG-RAN receives the List of Alternative QoS Profiles in operation 12, the NG-RAN may determine, from the List of Alternative QoS Profiles, a QoS Profile capable of satisfying the UL UE-Slice-MBR and the DL UE-Slice-MBR for QoS Flow.
In operation 15, the AMF may transmit an Nsmf_PDUSession_UpdateSMContext Request message to the SMF.
In operation 16, the SMF may transmit a N4 Session Modification Request message to the UPF. When the UPF receives the message, the UPF may transmit a N4 Session Modification Response message to the SMF.
In operation 17, the SMF may transmit an Nsmf_PDUSession_UpdateSMContext Response message to the AMF, as a response with respect to operation 15.

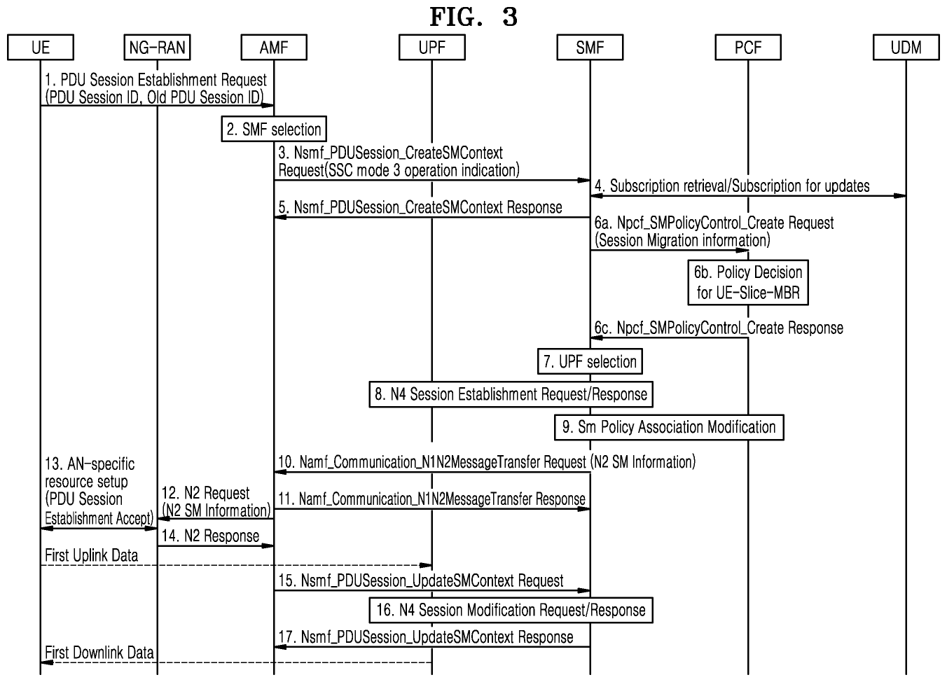

FIG. 3 illustrates a method of informing a PCF that request is a new PDU Session creation request for substituting an old PDU Session, when the PCF controls QoS Flow acceptance based on UE-Slice-MBR in a PDU Session creation procedure based on SSC mode 3, according to an embodiment of the present disclosure.

First, an SMF managing an old PDU Session operating in SSC mode 3 determines to change PDU Session Anchor (PSA)-UPF (or, PSA-UPF and SMF) with respect to the old PDU Session, and transmits a PDU Session Modification Command to a UE. Also, when the SMF determines an SMF change with respect to the PDU Session, the SMF transmits an SMF Reallocation requested indication to an AMF.
In operation 1, after the UE receives the PDU Session Modification Command from the old SMF, the UE may determine to perform a PDU Session Establishment procedure for connection to a DN that is the same DN of the old PDU Session. The UE transmits a PDU Session Establishment Request message to an AMF, thereby requesting creation of a new PDU Session. Here, based on considering that it is SSC mode 3 PDU Session, the UE may include a new PDU Session ID in a PDU Session ID in the PDU Session Establishment Request message, and may include, in an Old PDU Session ID, an ID of the old PDU Session to be released.
In operation 2, the AMF performs a SMF selection procedure for a new PDU Session. Here, when the SMF Reallocation requested indication is received from the SMF before operation 1 is performed, the AMF may select a new SMF.
In operation 3, when the message from the UE includes an Old PDU Session ID, the AMF transmits, to the SMF, a Nsmf_PDUSession_CreateSMContext Request including an SSC mode 3 operation indication.

According to an embodiment of the present disclosure, the SSC mode 3 operation indication may include the Old PDU Session ID. However, the present disclosure is not limited to the example above.

When the SMF receives the SSC mode 3 operation indication, the SMF may identify that the PDU Session creation request is a request for a new PDU Session for substituting the old PDU Session operating in SSC mode 3.
In operation 4, the SMF receives, from the UDM, subscriber information (e.g., Session Management Subscription data) associated with a session of the UE.

In detail, the SMF may request the data by transmitting a Nudm_SDM_Get Request message to the UDM, and may request subscription by transmitting a Nudm_SDM_Subscribe Request message. In an embodiment, the Nudm_SDM_Get Request message may include at least one of a SUPI, Session Management Subscription data, a selected DNN, S-NSSAI of the HPLMN, a Serving PLMN ID, or [NID]. In an embodiment, the Nudm_SDM_Subscribe Request message may include at least one of a SUPI, Session Management Subscription data, a selected DNN, S-NSSAI of the HPLMN, a Serving PLMN ID, or [NID].

When the UDM receives the data request message from the SMF, the UDM may obtain the data from the UDR and may transmit the data to the SMF.
In operation 5, the SMF transmits an Nsmf_PDUSession_CreateSMContext Response message to the AMF, as a response message with respect to operation 3.

Also, the SMF may perform Optional Secondary authentication/authorization on a PDU Session via a DN-AAA server.
In operation 6a, the SMF performs a procedure for selecting a PCF, and performs a Session Management (SM) Policy Association Establishment procedure with the PCF with respect to the PDU Session.

The SMF transmits an Npcf_SMPolicyControl_Create Request message to the PCF. For example, the Npcf_SMPolicyControl_Create Request message may include a SUPI, S-NSSAI, a DNN, an Access Type, etc.

When the SMF receives the SSC mode 3 operation indication in operation 3, the SMF may transmit the Npcf_SMPolicyControl_Create Request message including Session Migration Information to the PCF.

For example, the Session Migration Information may include an Old PDU Session ID of the SSC mode 3 operation indication received in operation 3. Also, the Session Migration Information may include a release timer value (e.g., a value transferred to the UE or a value being used by the SMF) with respect to the Old PDU Session (or the previous PDU session), QoS Flow ID(s) of the Old PDU Session, S-NSSAI of the Old PDU Session, or the like.

Also, the SMF may transmit N2 SM Information (information to be transmitted to the NG-RAN) including the Session Migration Information to the AMF, based on a result of local configuration.
In operation 6b, the PCF may determine a Policy for the UE-Slice-MBR. For example, when S-NSSAI (a slice for the PDU Session) received in operation 6a is subject to a limit of an MBR with respect to S-NSSAI for each UE, the PCF may perform policy determination with respect to the PDU Session by considering a uplink (UL) UE-Slice-MBR value (an MBR value of the UE for a corresponding slice in a UL direction) pre-received for the corresponding S-NSSAI and a bitrate of the UE which is being used in the UL direction for the corresponding S-NSSAI. Also, when the S-NSSAI (the slice for the PDU Session) received in operation 6a is subject to a limit of an MBR with respect to S-NSSAI for each UE, the PCF may perform traffic limit policy determination with respect to the PDU Session by considering a downlink (DL) UE-Slice-MBR value (an MBR value of the UE for a corresponding slice in a DL direction) pre-received for the corresponding S-NSSAI and a bitrate of the UE which is being used in the DL direction for the corresponding S-NSSAI.

In an embodiment, when the PCF receives the Session Migration Information in operation 6a, the PCF may not perform traffic limit policy determination with respect to the PDU Session, based on the UL UE-Slice-MBR or the DL UE-Slice-MBR with respect to the S-NSSAI (the slice for the PDU Session) received in operation 6a.

Also, even when the PCF does not receive the Session Migration Information in operation 6a, the PCF may configure, according to local configuration, a timer (e.g., a rejection determination delay timer) for delaying rejection determination with respect to QoS Flow, and may not perform rejection determination on QoS Flows for a PDU Session. In this case, when the rejection determination delay timer is expired, the PCF may perform rejection determination of QoS Flow due to the UE-Slice-MBR with respect to the QoS Flows. However, when at least one of a plurality of pieces of information is received before the rejection determination delay timer is expired, rejection determination may not be performed on the QoS Flows: information indicating that the QoS Flows are QoS Flows to substitute an old PDU Session, information requesting not to perform the UE-Slice-MBR on the QoS Flows, or the like.

Also, when the PCF receives the Session Migration Information in operation 6a, and the Session Migration Information includes Old PDU session ID, the PCF may perform policy determination, based on the UL UE-Slice-MBR value or the DL UE-Slice-MBR value with respect to the S-NSSAI (the slice for the PDU Session) received in operation 6a, in consideration of a UL bitrate usage and a DL bitrate usage with respect to a PDU Session corresponding to the Old PDU Session ID.

Also, when the PCF receives the Session Migration Information in operation 6a, and the Session Migration Information includes QoS Flow ID(s) of an Old PDU Session, and S-NSSAI of the Old PDU Session, the PCF may perform acceptance or rejection determination on each of QoS Flows due to the UL UE-Slice-MBR value or the DL UE-Slice-MBR value with respect to the S-NSSAI (the slice for the PDU Session) received in operation 6a, in consideration of a UL bitrate usage and a DL bitrate usage with respect to the QoS Flows (i.e., old QoS Flows) corresponding to the QoS Flow ID(s) or the S-NSSAI. In detail, even when a UE-Slice-MBR quota is insufficient, the PCF may additionally allow newly-requested QoS Flows by a total amount of bitrates for traffics (i.e., the old QoS Flows) corresponding to information specified in the Session Migration Information.
In operation 6c, the PCF may transmit an Npcf_SMPolicyControl_Create Response message to the SMF.
In operation 7, the SMF performs a procedure for selecting a UPF for the PDU Session.
In operation 8, the SMF transmits an N4 Session creation request for the PDU Session to the UPF, and the UPF transmits, to the SMF, a response message thereto.
In operation 9, when a Policy Control Request (PCR) Trigger condition received from the PCF in operation 6b is satisfied, the SMF performs a SM Policy Association Modification procedure and thus transmits information corresponding to the PCR Trigger to the PCF.
In operation 10, the transmits a SMF Namf_Communication_N1N2MessageTransfer Request message to the AMF. For example, the Namf_Communication_N1N2MessageTransfer Request message may include at least one of a PDU Session ID, N2 SM information, or a N1 SM container.

According to an embodiment of the present disclosure, the PDU Session ID may be an ID created for the PDU Session whose creation is requested by the SMF.

The N2 SM information may be information provided to the NG-RAN, and the N1 SM container may be information provided to the UE.

For example, the N2 SM information may include a PDU Session ID, QFI(s), QoS Profile(s), CN Tunnel Info, S-NSSAI from the Allowed NSSAI, Session-AMBR, or a PDU Session Type.

For example, the N1 SM container may include PDU Session Establishment Accept information. The PDU Session Establishment Accept information may include at least one of [QoS Rule(s) and QoS Flow level QoS parameters if needed for the QoS Flow(s) associated with the QoS rule(s)], a selected SSC mode, S-NSSAI(s), a UE Requested DNN, an allocated IPv4 address, interface identifier, Session-AMBR, or a selected PDU Session Type.
In operation 11, the AMF transmits a Namf_Communication_N1N2MessageTransfer Response message to the SMF, as a response with respect to operation 10.
In operation 12, the AMF may transmit N2 Request (N2 SM information), and a NAS message to the NG-RAN. The NAS message may include a PDU Session ID or a N1 SM container (PDU Session Establishment Accept).
In operation 13, the NG-RAN performs an operation of setting up resources for an AN with the UE, based on the information received from the SMF.

In an embodiment, the NG-RAN may transmit a PDU Session Establishment Accept message to the UE.
In operation 14, the NG-RAN transmits N2 Response to the AMF. The N2 Response may include at least one of PDU Session ID, Cause, or N2 SM information (PDU Session ID, AN Tunnel Info, List of accepted/rejected QFI(s)). Here, the List of accepted/rejected QFI(s) (QOS Flow ID(s)) may include information about a result of acceptance or rejection which is performed by the NG-RAN with respect to each QoS Flow of a PDU Session.
In operation 15, the AMF may transmit an Nsmf_PDUSession_UpdateSMContext Request message to the SMF.
In operation 16, the SMF may transmit a N4 Session Modification Request message to the UPF. When the UPF receives the message, the UPF may transmit a N4 Session Modification Response message to the SMF.
In operation 17, the SMF may transmit an Nsmf_PDUSession_UpdateSMContext Response message to the AMF, as a response with respect to operation 15.

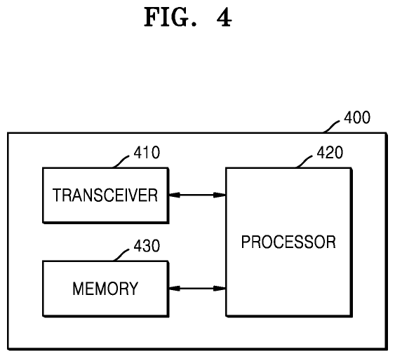

FIG. 4 is a block diagram schematically illustrating a configuration of a BS 400 entity according to an embodiment of the present disclosure. In an embodiment, the BS 400 may correspond to an NG-RAN shown in FIG. 1, FIG. 3, or FIG. 3.

Referring to FIG. 4, the BS 400 may include a transceiver 410, a processor 420, and a memory 430. According to the communication method of the BS 400, the transceiver 410, the processor 420, and the memory 430 of the BS 400 may operate. However, the elements of the BS 400 are not limited to the example described above. For example, the BS 400 may include more elements or fewer elements than the elements described above. In an embodiment, the transceiver 410, the processor 420, and the memory 430 may be implemented as one chip. Also, the processor 420 may include one or more processors.

The transceiver 410 is a collective term of a receiver of the BS 400 and a transmitter of the BS 400, and may transmit or receive a signal to or from a UE or a network entity. The signal being transmitted to or received from the UE or the network entity may include control information and data. To this end, the transceiver 410 may include a radio frequency (RF) transmitter for up-converting and amplifying a frequency of a signal to be transmitted, and an RF receiver for low-noise amplifying and down-converting a frequency of a received signal. However, this is merely an example of the transceiver 410, and elements of the transceiver 410 are not limited to the RF transmitter and the RF receiver.

Also, the transceiver 410 may perform functions for transceiving signals via wireless channels. Also, the transceiver 410 may receive signals via wireless channels and output the signals to the processor 420, and may transmit signals output from the processor 420, via wireless channels.

The memory 430 may store programs and data required to operate the BS 400. Also, the memory 430 may store control information or data included in a signal obtained by the BS. The memory 430 may be implemented as a storage medium including a read only memory (ROM), a random access memory (RAM), a hard disk, a compact disc (CD)-ROM, a digital versatile disc (DVD), or the like, or any combination thereof. Alternatively, the memory 430 may not be separately arranged but may be included in the processor 420. The memory 430 may be configured as a volatile memory, a non-volatile memory, or a combination of a volatile memory and a non-volatile memory. The memory 430 may provide stored data, in response to a request by the processor 420.

The processor 420 may control a series of processes to allow the BS 400 to operate according to the aforementioned embodiments of the present disclosure. For example, the processor 420 may receive a control signal and a data signal by using the transceiver 410, and may process the received control signal and the received data signal. The processor 420 may transmit the processed control signal and the processed data signal by using the transceiver 410. Also, the processor 420 may record data to and read data from the memory 430. The processor 420 may perform functions of a protocol stack which are requested by the communication rules. To do so, the processor 420 may include at least one processor or a micro-processor. In an embodiment, a part of the transceiver 410 or the processor 420 may be referred to as a communication processor (CP).

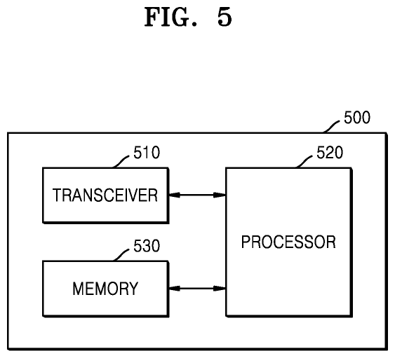

FIG. 5 is a block diagram schematically illustrating a configuration of a UE 500 entity according to an embodiment of the present disclosure.

Referring to FIG. 5, the UE 500 may include a processor 520, a memory 530, and a transceiver 510. However, the elements of the UE 500 are not limited to the example described above. For example, the UE 500 may include more elements or fewer elements than the elements described above. In an embodiment, the processor 520, the memory 530, and the transceiver 510 may be implemented as one chip.

The processor 520 may include one or more processors. In this case, the one or more processors may each be a general-purpose processor such as a central processing unit (CPU), an application processor (AP), a digital signal processor (DSP), or the like, a graphics-dedicated processor such as a graphics processing unit (GPU), a vision processing unit (VPU) or the like, or an artificial intelligence (AI)-dedicated processor such as a neural processing unit (NPU). For example, each of the one or more processors is the AI-dedicated processor, the AI-dedicated processor may be designed to have a hardware structure specialized for processing of a particular AI model.

The processor 520 may control a series of processes to allow the UE 500 to operate according to the aforementioned embodiments of the present disclosure. For example, the processor 520 may receive a control signal and a data signal by using the transceiver 510, and may process the received control signal and the received data signal. The processor 520 may transmit the processed control signal and the processed data signal by using the transceiver 510. Also, the processor 520 may control input data to be controlled based on a predefined operation rule or an AI model which are stored in the memory 530, the input data being derived from the received control signal and the received data signal. The processor 520 may record data to and read data from the memory 530. The processor 520 may perform functions of a protocol stack which are requested by the communication rules. According to an embodiment, the processor 520 may include at least one processor. In an embodiment, a part of the transceiver 510 or the processor 520 may be referred to as a CP.

The memory 530 may store programs and data necessary for operations of the UE 500. Also, the memory 530 may store control information or data which are included in a signal obtained by the UE 500. Also, the memory 530 may store the predefined operation rule or the AI model which are used by the UE 500. The memory 530 may be implemented as a storage medium including a ROM, a RAM, a hard disk, a CD-ROM, a DVD, or the like, or any combination thereof. Alternatively, the memory 530 may not be separately arranged but may be included in the processor 520. The memory 530 may be configured as a volatile memory, a non-volatile memory, or a combination of a volatile memory and a non-volatile memory. The memory 530 may provide stored data, in response to a request by the processor 520.

A transmitter and a receiver of the UE 500 may be collectively referred to as the transceiver 510, and the transceiver 510 of the UE 500 may transmit or receive a signal to or from a BS or a network entity. The signal transmitted to or received may include control information and data. To this end, the transceiver 510 may include a RF transmitter for up-converting a frequency of and amplifying signals to be transmitted, and an RF receiver for low-noise-amplifying and down-converting a frequency of received signals. However, this is merely an example of the transceiver 510, and thus elements of the transceiver 510 are not limited to the RF transmitter and the RF receiver. For example, the transceiver 510 may receive a signal via a wireless channel and output the signal to the processor 520, and may transmit a signal output from the processor 520, via a wireless channel.

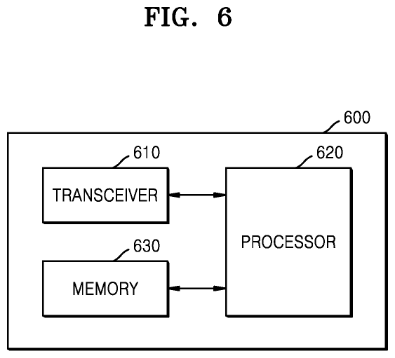

FIG. 6 is a block diagram schematically illustrating a configuration of a network entity 600 according to an embodiment of the present disclosure. In an embodiment, the network entity 600 may correspond to an AMF, a UPF, a SMF, a PCF, or a UDM shown in FIG. 1, FIG. 3, or FIG. 3.

Referring to FIG. 6, the network entity 600 may include a transceiver 610, a processor 620, and a memory 630. According to the communication method of the network entity 600, the transceiver 610, the processor 620, and the memory 630 of the network entity 600 may operate. However, the elements of the network entity 600 are not limited to the example described above. For example, the network entity 600 may include more elements or fewer elements than the elements described above. In an embodiment, the transceiver 610, the processor 620, and the memory 630 may be implemented as one chip. Also, the processor 620 may include one or more processors.

The transceiver 610 is a collective term of a receiver of the network entity 600 and a transmitter of the network entity 600, and may transmit or receive a signal to or from a UE or a BS. The signal being transmitted to or received from the UE or the BS may include control information and data.

Also, the transceiver 610 may perform functions for transceiving signals via wireless channels. Also, the transceiver 610 may receive signals via wireless channels and output the signals to the processor 620, and may transmit signals output from the processor 620, via wireless channels.

The memory 630 may store programs and data required to operate the network entity 600. Also, the memory 630 may store control information or data included in a signal obtained by the network entity 600. The memory 630 may be implemented as a storage medium including a ROM, a RAM, a hard disk, a CD-ROM, a DVD, or the like, or any combination thereof. Alternatively, the memory 630 may not be separately arranged but may be included in the processor 620. The memory 630 may be configured as a volatile memory, a non-volatile memory, or a combination of a volatile memory and a non-volatile memory. The memory 630 may provide stored data, in response to a request by the processor 620.

The processor 620 may control a series of processes to allow the network entity 600 to operate according to the aforementioned embodiments of the present disclosure. For example, the processor 620 may receive a control signal and a data signal by using the transceiver 610, and may process the received control signal and the received data signal. The processor 620 may transmit the processed control signal and the processed data signal by using the transceiver 610. Also, the processor 620 may record data to and read data from the memory 630. The processor 620 may perform functions of a protocol stack which are requested by the communication rules. To do so, the processor 620 may include at least one processor or a micro-processor. In an embodiment, a part of the transceiver 610 or the processor 620 may be referred to as a communication processor (CP).

As described above, according to an embodiment of the present disclosure, in a new PDU Session request requested to substitute a SSC Mode 3 PDU Session in the 5G system, it is possible to prevent a situation in which a QoS Flow is rejected or restricted due to a limit in a maximum bitrate usage of each slice for a UE.

Also, according to an embodiment of the present disclosure, an SMF-based solution scheme or a PCF-based solution scheme may be provided to appropriately reflect data used via an old PDU Session to a Remaining Allowed Usage value when a UPF or an SMF for a SSC Mode 3 PDU Session is changed in a wireless communication system.

While the present disclosure has been particularly shown and described with reference to the accompanying drawings, in which embodiments of the present disclosure are shown, it is obvious to one of ordinary skill in the art that the present disclosure may be easily embodied in many different forms without changing the technical concept or essential features of the present disclosure. Thus, it should be understood that the embodiments described herein should be considered in a descriptive sense only and not for purposes of limitation. For example, configuring elements that are singular forms may be executed in a distributed fashion, and also, configuring elements that are distributed may be combined and then executed.

The scope of the present disclosure is defined by the appended claims, rather than defined by the aforementioned detailed descriptions, and all differences and modifications that can be derived from the meanings and scope of the claims and other equivalent embodiments therefrom will be construed as being included in the present disclosure.

1. An operating method of a Session Management Function (SMF) entity in a wireless communication system, the operating method comprising:
receiving, from an Access And Mobility Management Function (AMF) entity, a Protocol Data Unit (PDU) session creation request message;
receiving, from a Unified Data Management (UDM) entity, subscriber information associated with a session of a user equipment (UE);
transmitting, to the AMF entity, a response message with respect to the PDU session creation request message;
selecting a Policy Control Function (PCF) entity;
transmitting, to the selected PCF entity, a session management policy information creation request message comprising Session Migration Information;
receiving, from the PCF entity, policy information about a PDU Session which is determined based on a maximum bitrate (MBR) value (UE-Slice-MBR) corresponding to a slice for the PDU Session; and
selecting a User Plane Function (UPF) entity to support session continuity by considering an MBR, based on the policy information about a PDU Session.

2. The operating method of claim 1, wherein
the PDU session creation request message comprises identifier (ID) information about a new PDU Session and ID information about an old PDU Session to be released.

3. The operating method of claim 1, further comprising:
performing authentication on the PDU Session via a Data Network Authentication, Authorization and Accounting (DN-AAA) server.

4. The operating method of claim 1, further comprising establishing a session management policy in association with the PCF entity.

5. The operating method of claim 1, wherein
the Session Migration Information comprises at least one of an ID release timer value for the old PDU Session, a Quality-of-Service (QOS) flow ID, or Single-Network Slice Selection Assistance Information (S-NSSAI).

6. The operating method of claim 1, further comprising transmitting the Session Migration Information to the AMF entity.

7. The operating method of claim 1, wherein
the policy information about the PDU Session comprises an alternative QoS parameter set with respect to the PDU Session.

8. An operating method of an Access And Mobility Management Function (AMF) entity in a wireless communication system, the operating method comprising:
receiving, from a user equipment (UE), a Protocol Data Unit (PDU) session creation request message;
selecting a Session Management Function (SMF) entity for a new PDU Session;
transmitting, to the selected SMF entity, the PDU session creation request message; and
receiving, from the SMF entity, a response message with respect to the PDU session creation request message.

9. The operating method of claim 8, wherein
the PDU session creation request message comprises identifier (ID) information about a new PDU Session and ID information about an old PDU Session to be released.

10. The operating method of claim 9, further comprising:
identifying, based on the ID information about the old PDU Session, whether the old PDU Session is a slice to which a slice-maximum bitrate (MBR) control function is applied; and
transmitting, to a base station, result information about the identifying.

11. A Session Management Function (SMF) entity for supporting session continuity by considering a maximum bitrate (MBR) in a wireless communication system, the SMF entity comprising:
a transceiver; and
at least one processor,
wherein the at least one processor is configured to
receive, from an Access And Mobility Management Function (AMF) entity, a Protocol Data Unit (PDU) session creation request message, receive, from a Unified Data Management (UDM) entity, subscriber information associated with a session of a user equipment (UE),
transmit, to the AMF entity, a response message with respect to the PDU session creation request message,
select a Policy Control Function (PCF) entity,
transmit, to the selected PCF entity, a session management policy information creation request message comprising Session Migration Information,
receive, from the PCF entity, policy information about a PDU Session which is determined based on a maximum bitrate (MBR) value (UE-Slice-MBR) corresponding to a slice for the PDU Session, and
select a User Plane Function (UPF) entity to support session continuity by considering an MBR, based on the policy information about a PDU Session.

12. The SMF entity of claim 11, wherein
the PDU session creation request message comprises identifier (ID) information about a new PDU Session and ID information about an old PDU Session to be released.

13. The SMF entity of claim 11, wherein
the Session Migration Information comprises at least one of an ID release timer value for the old PDU Session, a Quality-of-Service (QOS) flow ID, or Single-Network Slice Selection Assistance Information (S-NSSAI).

14. The SMF entity of claim 11, wherein
the at least one processor is configured to transmit, via the transceiver,
the Session Migration Information to the AMF entity.

15. The SMF entity of claim 11, wherein
the policy information about the PDU Session comprises an alternative QoS parameter set with respect to the PDU Session.
